(19) United States
(12) Patent Application Publication
(10) Pub. No.: US 2012/0018453 A1
(43) Pub. Date: Jan. 26, 2012

(54) AEROSOL DISPENSER

(76) Inventor: Nathan R. Westphal, Union Grove, WI (US)

(21) Appl. No.: 13/138,768

(22) PCT Filed: Mar. 26, 2010
(86) PCT No.: PCT/US10/00910

§ 371 Date: Sep. 26, 2011

(30) Foreign Application Priority Data
Mar. 27, 2009 (EP) 09156445.0

(51) Int. Cl. B67D 7/84

(52) U.S. Cl. 222/162

(57) ABSTRACT

A dispenser includes a housing 52 having curvilinear sides 54, a top end 56, and a bottom end 58. At least one face of the curvilinear sides 54 is shaped to appear like a natural occurring object and includes a portion between the top end 56 and the bottom end 58 that extends radially from a longitudinal axis 66 of the housing 52 to a greater extent than portions at the top end 56 and the bottom end 58. A bore 60 extends through the housing 52, which is adapted to receive a container 100. The container 100 is adapted to dispense fluid through a first aperture 62 of the bore 60 in the top end 56 of the housing 52. Fluid is dispensed from the container 100 through the first aperture 62 upon telescopically moving the housing 52 by exerting a force against the at least one face of the curvilinear sides 54 shaped to appear like a natural occurring object in a direction parallel to the longitudinal axis 66 of the housing 52.

### CROSS REFERENCE TO RELATED APPLICATIONS

Not applicable

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present disclosure relates generally to a dispenser for the release of a volatile material from a container, and more particularly, to a dispenser that includes a housing having a smooth or textured surface that lacks discontinuities for actuating an aerosol container.

2. Description of the Background of the Invention

Aerosol containers are commonly used to store and dispense a variety of possible volatile materials such as air fresheners, deodorants, insecticides, germicides, decongestants, perfumes, and the like. The volatile material is stored under compression and a release valve on the aerosol container controls release of the volatile material. The release valve is activated by actuation of a valve stem through which the volatile material flows. However, aerosol containers typically include unwieldy canisters that are not ergonomically fashioned for ease of use and that appear intrusive in many home or work environments. The present disclosure provides an aerosol dispenser for housing an aerosol container in an ergonomically actuable housing, which appears like a naturally occurring object.

### SUMMARY OF THE INVENTION

According to a first aspect of the invention, a dispenser includes a housing 52 having curvilinear sides 54, a top end 56, and a bottom end 58. At least one face of the curvilinear sides 54 is shaped to appear like a naturally occurring object and includes a portion between the top end 56 and the bottom end 58 that extends radially from a longitudinal axis 66 of the housing 52 to a greater extent than portions at the top end 56 and the bottom end 58. A bore 60 extends through the housing 52, which is adapted to receive a container 100. The container 100 is adapted to dispense fluid through a first aperture 62 of the bore 60 in the top end 56 of the housing 52. Fluid is dispensed from the container 100 through the first aperture 62 upon telescopically moving the housing 52 by exerting a force against the at least one face of the curvilinear sides 54 shaped to appear like a naturally occurring object in a direction parallel to the longitudinal axis 66 of the housing 52. Preferred naturally occurring objects are a pebble, a stone and a shell. The housing 52 may thus be shaped such that at least from one direction it looks like, e.g. it has the shape and surface texture of, a pebble. Preferably the housing has the shape and surface texture of a pebble when viewed from any side.

According to another a second aspect of the invention, a dispenser includes a housing 52 having a bore 60 extending therethrough. The bore 60 has first and second apertures 62, 64. An actuator socket 204, 300 is disposed within the first aperture 62, which includes a passage 206, 304 extending therethrough that is in fluid communication with the first aperture 62. A shroud 200, 250 is disposed within the bore 60. The shroud 200, 250 includes a channel within an interior thereof. An adapter 350 engages the shroud 200, 250 and is disposed within the second aperture 64. An aerosol container 100 is disposed within the channel of the shroud 200, 250. The shroud 200, 250 has shoulders 218 to hold the aerosol container 100 at an axially fixed position with respect to the shroud 200, 250. A valve stem 114 of the aerosol container 100 is urged by the actuator socket 204, 300 such that displacement of the housing 52 toward the shroud 200, 250 axially compresses the valve stem 114 to cause the aerosol container 100 to emit fluid through the passage 206, 304 and the first aperture 62. The shroud 200, 250 slidably engages the housing 52 to allow a limited telescopic movement therebetween. Further, the adapter 350 releasably engages a lower margin of the shroud 200, 250 to enable the shroud 200, 250 and the aerosol container 100 to be removed axially as a unit. Arrangements in accordance with the second aspect of the invention may also be in accordance with the first aspect. In the dispenser according to the second aspect of the invention wherein the shroud (200) may includes a body portion (202) and flexible members (208) extending between the body portion (202) and the actuator socket (204). Optionally the shroud (200) is provided with an aerosol container (100) installed therein such that the valve stem (114) of the aerosol container (100) is disposed within an inlet (220) of the actuator socket (204) and the actuator socket (204) is in fluid communication with the first aperture (62). In this case a further actuator socket (300) may be disposed between the actuator socket (204) and portions of the housing adjacent the first aperture (62), wherein the passage (206) of the actuator socket (204) is in fluid communication with the passage (304) of the actuator socket (300) and the first aperture (62). In this case an intermediate chamber (306) may be formed between the passage (206) of the actuator socket (204) and the passage (304) of the further actuator socket (300), wherein the intermediate chamber (306) provides a disruption to a flow of the fluid dispensed from the aerosol container (100) to promote mixing and atomization thereof before release to the environment.

### BRIEF DESCRIPTION OF THE DRAWINGS

FIG. 1 is an isometric view of a first embodiment of an aerosol dispenser;

FIG. 2 is a top plan view of the aerosol dispenser of FIG. 1;

FIG. 3 is a side elevational view of the aerosol dispenser of FIG. 1;

FIG. 4 is a bottom elevational view of the aerosol dispenser of FIG. 1;

FIG. 5 is a side elevational view of an aerosol container, with alternative embodiments of the aerosol container shown in dashed lines;

FIG. 6 is side elevational view of a first embodiment of a shroud for use with the aerosol dispenser of FIG. 1;

FIG. 7 is another side elevational view of the shroud of FIG. 6;

FIG. 8 is a top plan view of the shroud of FIG. 6;

FIG. 9 is a sectional view of the shroud taken along the line 8-8 of FIG. 8;

FIG. 10 is an enlarged, partial sectional view of the aerosol dispenser of FIG. 1 in combination with the shroud of FIG. 6 and the aerosol container of FIG. 5;

FIG. 11 is a side elevational view of a second embodiment of a shroud;

FIG. 12 is a side elevational view of an actuator socket;

FIG. 13 is a top plan view of the actuator socket of FIG. 12;

FIG. 14 is a side elevational of the actuator socket taken along the line 14-14 of FIG. 13;

FIG. 15 is an enlarged, partial sectional view of the aerosol dispenser of FIG. 1 in combination with the shroud of FIG. 11 and the aerosol container of FIG. 5;

FIG. 16 is an enlarged, partial sectional view of the aerosol dispenser of FIG. 1 in combination with the actuator socket of FIG. 12, the shroud of FIG. 6, and the aerosol container of FIG. 5;

FIG. 17 is a side elevational view of an adapter;

FIG. 18 is a top plan view of the adapter of FIG. 17;

FIG. 19 is a sectional view of the adapter taken along the line 19-19 of FIG. 18; and

FIG. 20 is a partial sectional view of the aerosol dispenser of FIG. 1 in combination with the shroud of FIG. 6 and the aerosol container of FIG. 5.

Other aspects and advantages of the present invention will become apparent upon consideration of the following detailed description, wherein similar structures have similar reference numerals.

### DETAILED DESCRIPTION

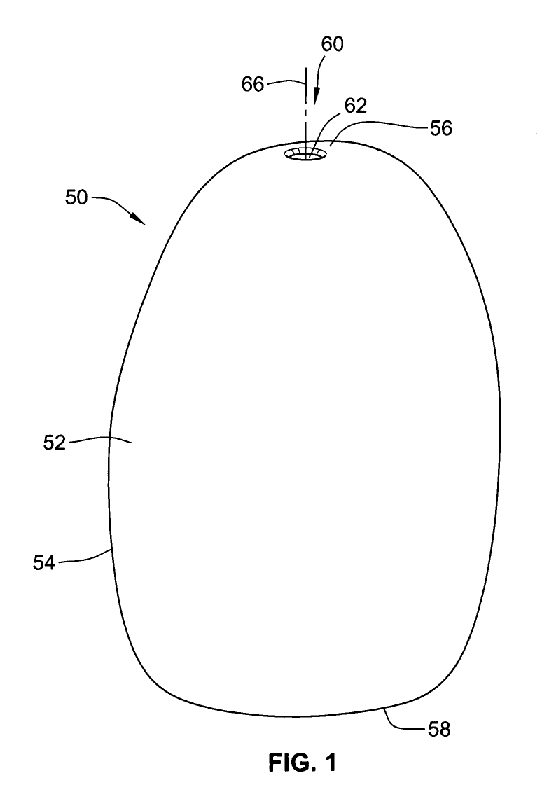

A first embodiment of an aerosol dispenser 50 is depicted in FIGS. 1-4. The aerosol dispenser 50 includes a housing 52 having smooth or textured curvilinear sides 54 between a top end 56 and a bottom end 58. A bore 60 extends longitudinally through the housing 52 and includes a first aperture 62 at the top end 56 thereof and a second aperture 64 at the bottom end 58 thereof. The first and second apertures 62, 64 are each centered along a longitudinal axis 66 of the housing 52. A groove 68 extends around a periphery of the second aperture 64. Two opposing lips 70 extend interiorly from a surface 72 of the housing 52 adjacent the groove 68.

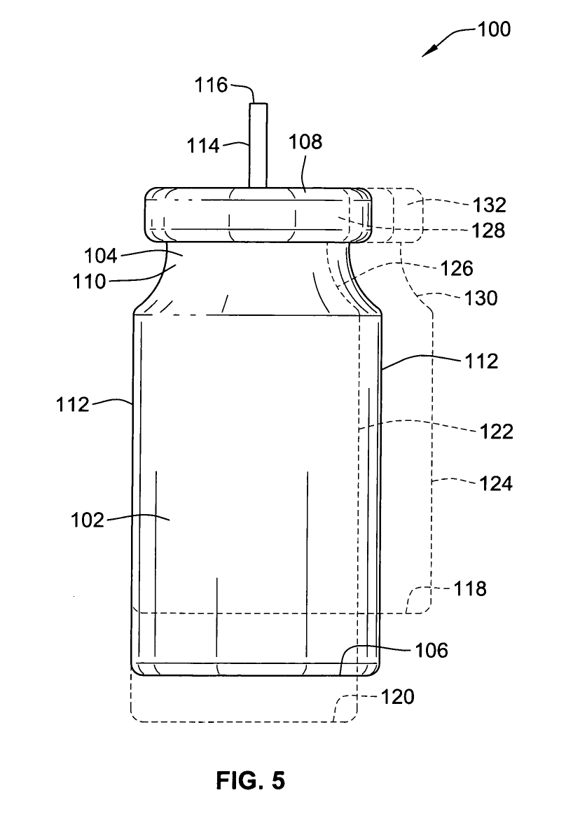

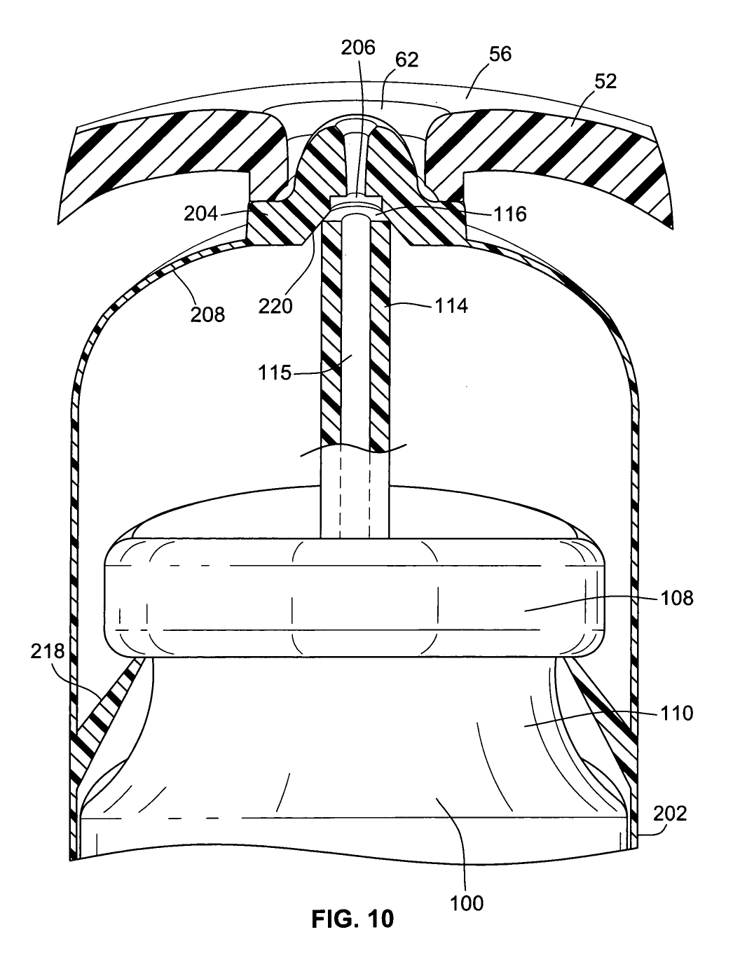

Aerosol containers, such as the aerosol container 100 depicted in FIG. 5, are well known to those skilled in the art. The aerosol container 100 comprises a body 102 with a top end 104 and a bottom end 106. A mounting cup 108 is disposed above a neck 110 of the aerosol container 100. The body 102 is generally cylindrical in geometry and includes a wall 112. A valve assembly (not shown) within an upper portion of the aerosol container 100 includes a valve stem 114 that extends through the mounting cup 108. The valve stem 114 is a cylindrical tube having a passage 115 (see FIG. 10) disposed longitudinally therethrough. A distal end 116 of the valve stem 114 extends upwardly and away from the mounting cup 108 and a proximal end (not shown) is disposed within the valve assembly. The mounting cup 108 may optionally include a peripheral flange (not shown) that extends radially outwardly from a periphery of the mounting cup 108. The peripheral flange may be a part of the mounting cup 108 or may be an annular cap (not shown), which attaches over the mounting cup 108 such that the flange extends radially outwardly therefrom.

Axial compression, i.e., downward movement, of the valve stem 114 opens the valve assembly, which allows a pressure difference between an interior of the aerosol container 100 and the atmosphere to force the contents of the aerosol container 100 out through the distal end 116 of the valve stem 114. It is also contemplated that the aerosol container 100 could utilize a tilt activated valve stem with minimal or no modifications to the structure disclosed hereinafter. Further, in other embodiments a container 100 having a metered valve pump sprayer is used in lieu of an aerosol container to hold and dispense the volatile material.

Referring again to FIG. 5, the aerosol container 100 may have one of a multiplicity of diameters and/or lengths. For example, using the solid lines in FIG. 5 as a basis for comparison, the aerosol container 100 may have a length that is shorter or longer than the basis as illustrated by the dashed lines 118 and 120, respectively. Similarly, the aerosol container 100 may have a width that is narrower or wider than the basis as illustrated by the dashed lines 122 and 124, respectively. The aerosol container 100 having the narrower width 122 would also have a correspondingly narrower neck 126 and mounting cup 128. Similarly, the container 100 having the wider width 124 would also have a correspondingly wider neck 130 and mounting cup 132.

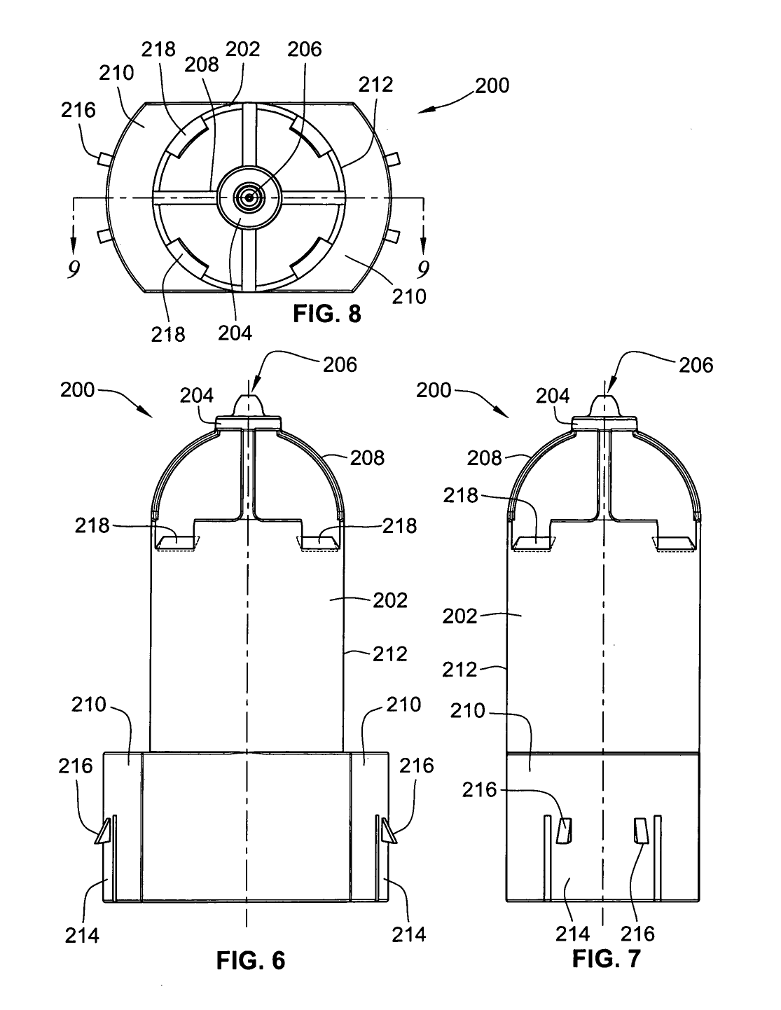

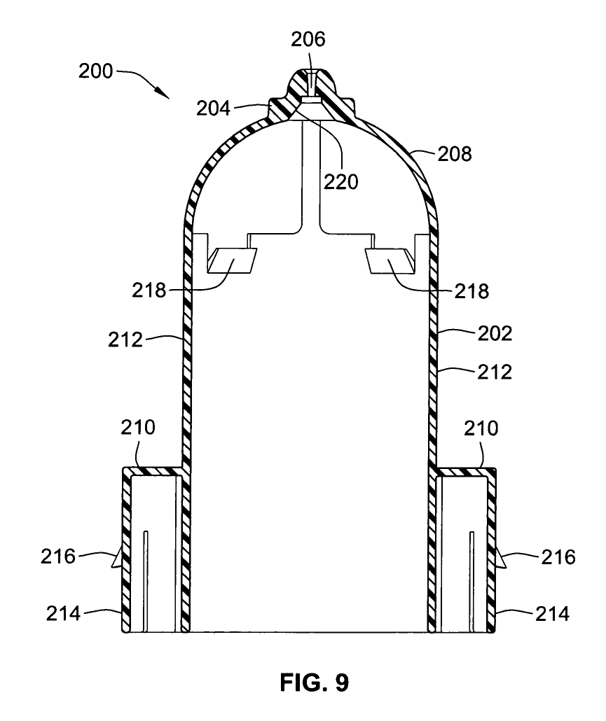

The aerosol dispenser 50 includes structure that can accommodate aerosol containers having a multiplicity of widths and lengths. An element of this structure is a first embodiment of a shroud 200, illustrated in FIGS. 6-9. The shroud 200 includes a body portion 202 flexibly attached to an actuator socket 204. The actuator socket 204 includes a passage 206 extending therethrough. The actuator socket 204 is attached to the body portion 202 by flexible members 208. The flexible members 208 allow one or both of the actuator socket 204 and the body portion 202 to be displaced toward one another. A bottom end of the shroud 200 includes shoulders 210 extending from an exterior surface 212 of the shroud 200. Each shoulder 210 includes a flexible arm 214 that has at least one tapered protrusion 216 extending outwardly therefrom. The protrusions 216 are adapted to engage a support member on an interior surface of an adapter, as discussed in greater detail below.

The shroud 200 is adapted to receive the aerosol container 100 therein such that the valve stem 114 of the aerosol container 100 is disposed within the actuator socket 204, as illustrated in FIG. 10. Referring now to FIGS. 6-10, the shroud 200 includes flexible internal shoulders 218 that snap over the mounting cup 108 on the aerosol container 100. In use, the internal shoulders 218 fixedly hold the aerosol container 100 with respect to the body portion 202 of the shroud 200. An inlet 220 of the actuator socket 204 is sized to accommodate the valve stem 114 of the aerosol container 100. With the aerosol container 100 thus installed within the shroud 200, the valve stem 114 is in contact with the actuator socket 204. However, in the present rest state the valve stem 114 is not pressed by the actuator socket 204 to a degree sufficient to open the assembly within the aerosol container 100. Preferably however, the degree of pressure should be sufficient to ensure that at all times a seal is maintained between the actuator socket 204 and the valve stem. This may involve a small amount of inward displacement of the valve stem even in the rest state, but not sufficient to operate the valve. Thus, the can is held axially within the shroud. Unwanted downward movement is prevented by the internal shoulders 218 and unwanted upward movement is prevented by the spring loading within the valve stem. As the aerosol container is supported only at its neck portion, cans of different lengths can readily be accommodated in the same shroud.

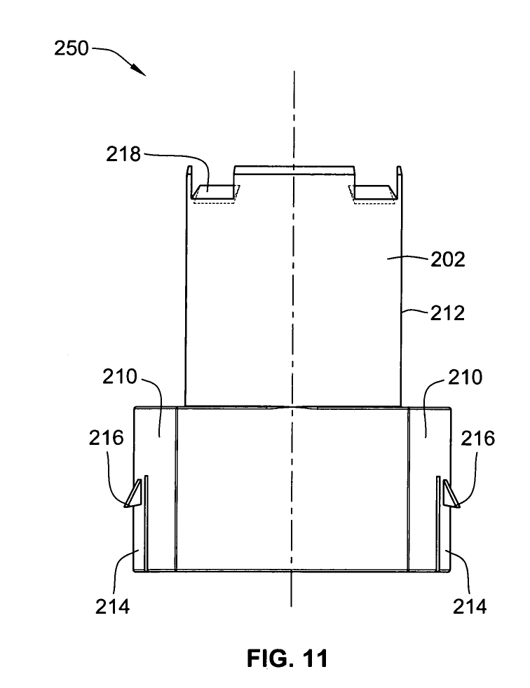

Turning to FIGS. 11-15, a second embodiment of an aerosol dispenser 230 is shown. The aerosol dispenser 230 includes a shroud 250 (see FIG. 11). The shroud 250 is substantially similar to the shroud 200 discussed hereinabove with respect to FIGS. 6-9, except that the shroud 250 lacks the actuator socket 204 and the flexible members 208. In addition, the shroud 250 may have one or more ribs or raised ridges (not shown) running vertically, i.e., parallel to a longitudinal axis of the shroud 250, on the exterior surface 212 thereof, wherein each rib or ridge extends from one of the internal shoulders 218 toward the shoulders 210 or bottom end of the shroud 250. The ribs or ridges are sized to provide clearance within the bore 60 to allow for easy insertion therein and removal therefrom. Further, the ribs or ridges are also sized to make contact with surfaces defining the bore 60 upon excessive outward flexing of the internal shoulders 218.

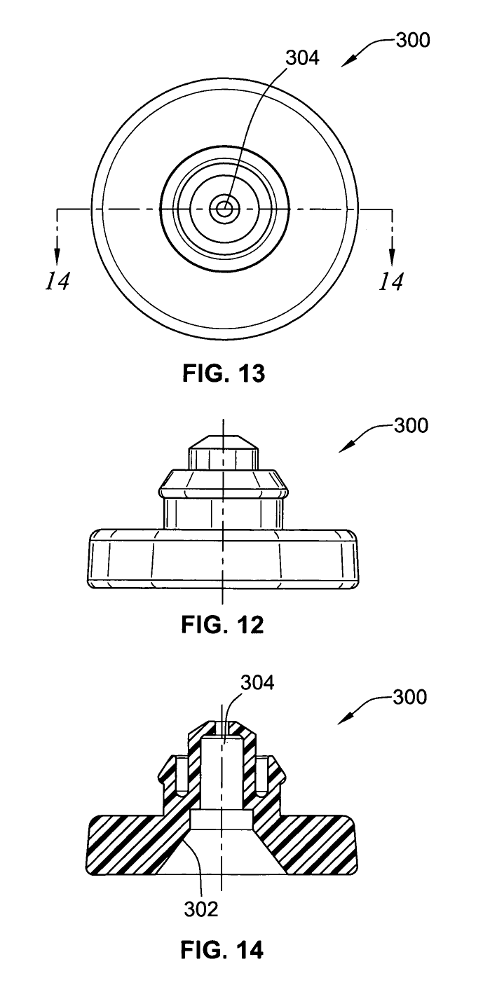

The shroud 250 is utilized in conjunction with an actuator socket 300, which is illustrated in FIGS. 12-15. The actuator socket 300 includes a frusto-conical inlet portion 302 and a passage 304 extending therethrough. The frusto-conical inlet portion 302 is adapted to receive any of a plurality of valve stems of an aerosol container having a uniformly cylindrical cross-section or a non-uniform cylindrical cross-section. The actuator socket 300 fits within the first aperture 62 and is held therein by, for example, a press fit, a snap fit, an adhesive, or any other securing means. In a different embodiment, the actuator socket 300 is integral with a portion of the housing 52. Once thus disposed in the first aperture 62, the actuator socket 300 and the shroud 250 hold the aerosol container 100 therebetween with the valve stem 114 in contact with the actuator socket 300.

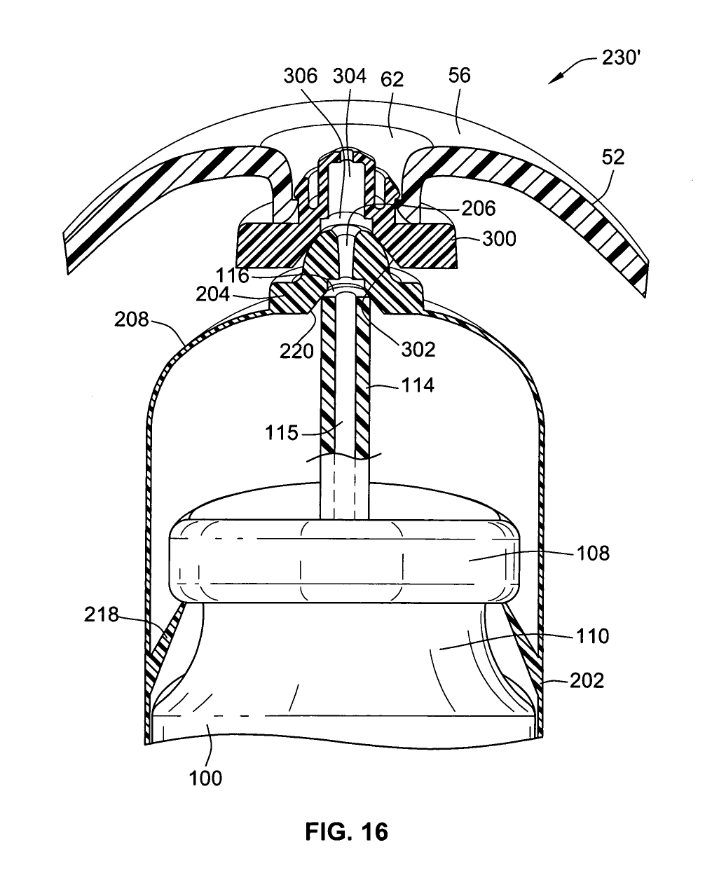

It is also contemplated that the shroud 200 could be utilized in conjunction with the actuator socket 300. In such an embodiment, illustrated as aerosol dispenser 230′ in FIG. 16, passages 206 and 304, which extend through the actuator sockets 204 and 300, respectively, are guided into alignment and fluid communication by the frusto-conical inlet portion 302. This is made possible by the ability of the inlet portion 302 to receive the bulbous end of the actuator socket 204, which has a non-uniform cylindrical cross-section. An intermediate chamber 306 is formed between the passages 206 and 304. The intermediate chamber 306 may provide a disruption to a flow of the fluid dispensed from the aerosol container 100 to promote mixing and atomization thereof before release to the environment.

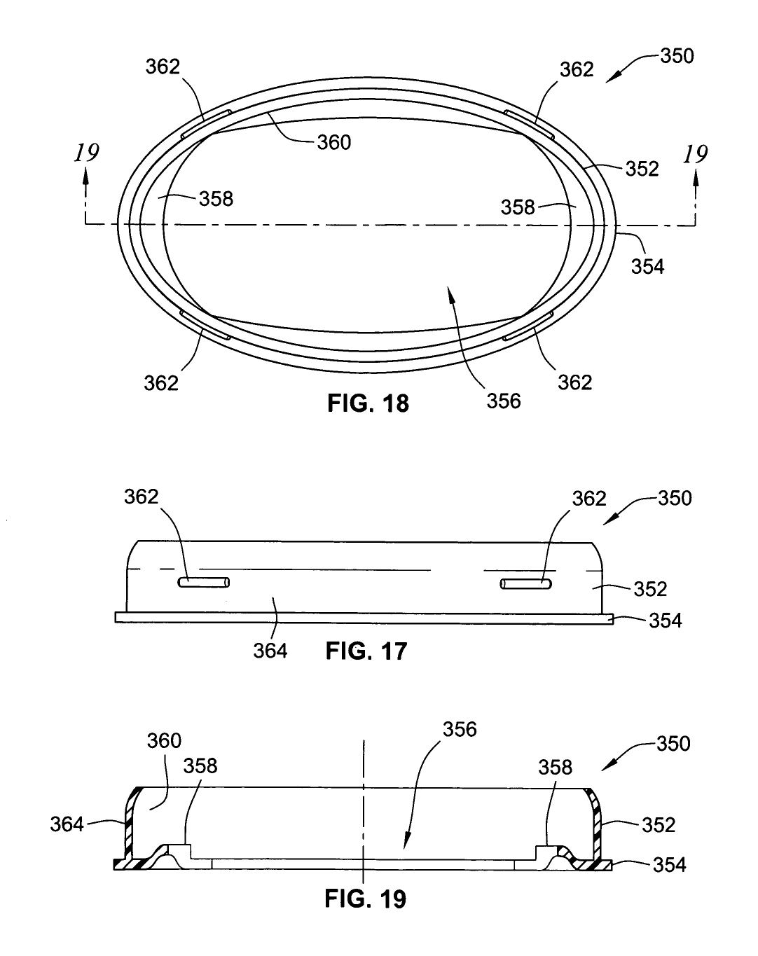

Referring to FIGS. 17-19, an adapter 350 is illustrated including a generally elliptical wall 352 extending upwardly from a similarly shaped base 354. An aperture 356 is disposed through the base 354 and includes four curvilinear sides that are generally similar to the size of a lower portion of the shroud 200, 250. Two support members 358 are disposed on opposing sides of the interior surface 360 of the wall 352. One or more protrusions 362 extend from an external surface 364 of the wall 352. The adapter 350 may optionally include one or more tapered vertical ribs (not shown), which extend from the interior surface 360 of the wall 352 and taper downwardly toward an interior lip of the base 354 adjacent the aperture 356.

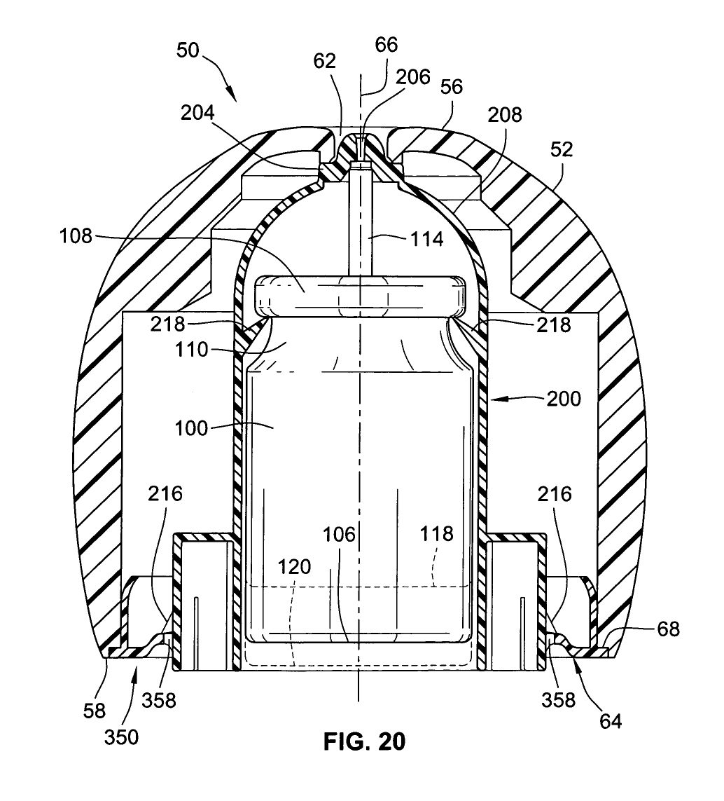

Having described the component parts of the aerosol dispenser 50 hereinabove, the inter-relation of all of the parts will now be described. Referring to FIG. 20, the aerosol dispenser 50 is shown in cross-section fully assembled. Assembly of the aerosol dispenser 50 may be described sequentially. First, the aerosol container 100 is placed within the shroud 200 such that the flexible internal shoulders 218 snap over the mounting cup 108 on the aerosol container 100 to fixedly hold the aerosol container 100 with respect to the body portion 202 of the shroud 200. The neck 110 of the aerosol container 100 provides a recess into which the shoulders 218 extend to hold the aerosol container 100. The valve stem 114 of the aerosol container 100 is accommodated by and in contact with the actuator socket 204. As indicated by the dashed lines 118, 120 in FIG. 20, the aerosol container 100 may have any number of different lengths. The aerosol container 100 may also have any number of different widths (not shown in FIG. 20), which may be accommodated by the shroud 200 and the internal shoulders 218.

The adapter 350 is placed into the second aperture 64 so that the one or more protrusions 362 thereon snap over the lips 70 (FIG. 4) extending from the interior surface 72 of the housing 52. The base 354 of the adapter 350 is accommodated by the groove 68 around the periphery of the second aperture 64 such that a bottom surface of the adapter 350 is flush with the bottom end 58 of the housing 52. A user may remove the adapter 350 from the second aperture 64 by simply reversing this process and pulling the adapter 350 out of the second aperture 64.

The shroud 200 with the aerosol container 100 held within is inserted into the housing 52 through the aperture 356 of the adapter 350 until the tapered protrusions 216 snap over the support members 358. The aerosol dispenser 50 is in a rest state when a top end of the shroud 200, i.e., the actuator socket 204, is in physical communication with a portion of the housing 52 defining the first aperture 62 and the tapered protrusions 216 are in physical communication with the support members 358. As illustrated in FIG. 20, in the rest state, the lower portion of the shroud 200 extends from the second aperture 64 and is held adjacent a support surface (not shown). Exertion of a downward force component onto the housing 52 causes same to move axially downward, i.e., in a direction parallel to the longitudinal axis 66, in relation to the shroud 200, thereby causing compression of the valve stem 114 and the resultant release of the contents of the aerosol container 100.

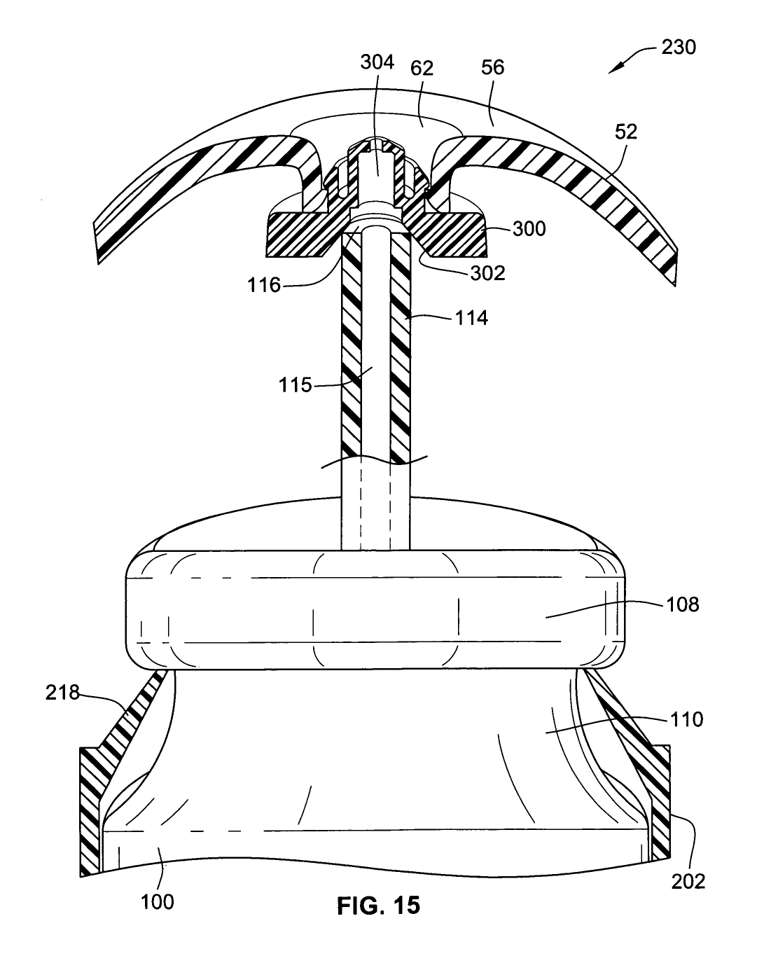

Turning again to the aerosol dispenser 230 depicted in FIG. 15, the operation of the dispenser 230 is substantially similar to the aerosol dispenser 50 described hereinabove with regard to FIG. 20. The aerosol container 100 is placed into the shroud 250 and inserted into the housing 52 in a similar manner as described in connection with FIG. 20. The aerosol dispenser 230 is in a rest state with the distal end 116 of the valve stem 114 in physical communication with the actuator socket 300 and the tapered protrusions 216 in physical communication with the support members 358. In the rest state, a lower portion of the shroud 250 extends from the second aperture 64 (see FIG. 20). Exertion of a downward force component onto the housing 52 causes same to move axially downward in relation to the shroud 250, thereby causing compression of the valve stem 114 and the resultant release of the contents of the aerosol container 100. The optional flange extending radially outwardly from the periphery of the mounting cup 108 may provide additional surface area against which upper ends of the internal shoulders 218 may push. In addition, the ribs or raised ridges associated with the internal shoulders 218 add strength to same to inhibit collapse of the internal shoulders 218 by the exertion of a downward force component onto the housing 52.

The distal end 116 of the valve stem 114 may tend to press fit into the actuator socket 300 upon use and resist removal when the aerosol container 100 is desired to be replaced. When removing the shroud 250 from the housing 52, the tapering neck 110 may cause the internal shoulders 218 to be pushed radially outwardly and to slip past the neck 110 and over the body 102, thereby leaving the aerosol container 100 within the bore 60. The optional ribs or raised ridges add strength to the internal shoulders 218 to inhibit separation thereof during removal of the shroud 250. Further, in instances of both actuation and aerosol container removal, the ribs or raised ridges on the exterior surface 212 of the shroud 250 are sized to contact surfaces defining the bore 60 to prevent excessive outward flexing of the internal shoulders 218. Additionally, the optional tapered vertical ribs that extend from the interior surface 360 of the adapter 350 inhibit the mounting cup 108, or the peripheral flange optionally associated therewith, from catching on the base 354 when removing the aerosol container 100 from the housing 52.

As noted above, another embodiment of an aerosol dispenser 230′ is illustrated in FIG. 16. The aerosol dispenser 230′ is substantially similar to the aerosol dispenser 50 described hereinabove with regard to FIG. 20 except for the following difference. The actuator socket 204 is retained within the inlet portion 302 of the actuator socket 300 and the actuator socket 300 is disposed adjacent surfaces of the housing 52 defining the first aperture 62. The aerosol dispenser 230′ otherwise operates in an identical fashion as the aerosol dispensers 50, 230 described hereinabove and includes a rest state wherein a lower portion of the shroud 200 extends from the second aperture 64.

It is contemplated that any of the aerosol dispensers 50, 230, 230′ described hereinabove could be utilized, for example, by placing the aerosol dispenser 50, 230, 230′ on a support surface with the first aperture 62 facing away from the support surface and the second aperture 64 facing downwardly toward the support surface. Subsequent downward force applied to the housing 52 results in same telescopically sliding about the longitudinal axis 66, or substantially parallel thereto, in relation to the shroud 200, 250. Displacement of the housing 52 results in axial compression of the valve stem 114, which opens the valve assembly within the aerosol container 100. Fluid emitted from the aerosol container 100 passes through the passage 115 of the valve stem 114, out the distal end 116 thereof, through the respective actuator socket 204, 300, out the first aperture 62, and into the ambient environment.

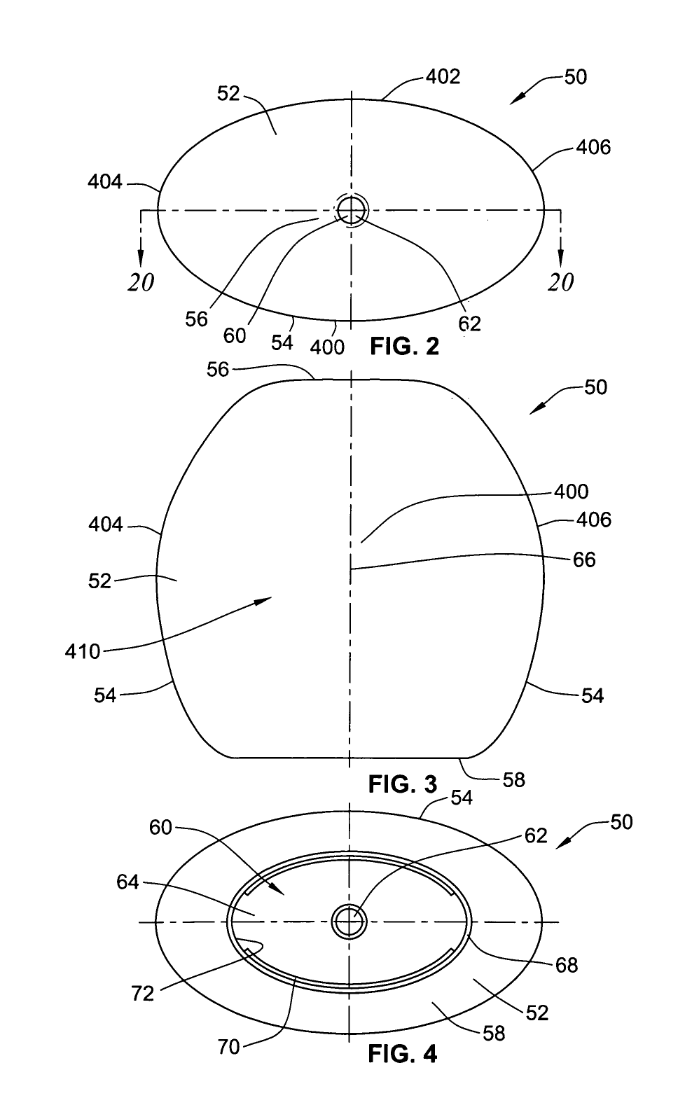

A user's grip on the housing during axial movement thereof is important to effective dispensing. Turning to FIGS. 2 and 3, the housing 52 is provided with smooth or textured curvilinear sides 54, wherein the curvilinear sides 54 lack any discontinuities, straight lines, or right angles. The curvilinear sides 54 comprise first and second faces 400, 402, respectively, having width dimensions substantially greater than third and fourth faces 404, 406, respectively. A medial portion 410 of the faces 400-406 extends radially outwardly from the longitudinal axis 66 of the housing 52 to a greater extent than portions of the faces 400-406 adjacent the top end 56 and the bottom end 58. However, it is anticipated that one or more other and/or different portions of the housing 52 may extend radially outwardly from the longitudinal axis 66 to a greater extent. Alternatively, the faces 400-406 may extend radially outwardly from the longitudinal axis 66 of the housing 52 the entire length of the housing 52 between the top end 56 and the bottom end 58.

The tapering cross-sectional width of the housing 52 provides an ergonomic gripping surface that conforms to the contour of a user's palm and/or fingers when gripping the housing 52. Indeed, it has been found that the varying cross-sectional width affords any shape of hand a comfortable resting place to effectively grip the housing 52, i.e., smaller hands may find it more comfortable to grip the housing 52 to a greater extent above the medial portion 410 than a user with a larger hand. Further, a user may grip the housing 52 so as to place their palm adjacent the faces 400, 402 with a greater width, the faces 404, 406 with a smaller width, or any combination thereof. It is anticipated that the slope and degree to which the faces 400-406 taper outwardly from the top end 56 toward the medial portion 410 and inwardly from the medial portion 410 to the bottom end 58, may be varied. It is also anticipated that the widths of any of the faces 400-406 may be varied. However, keeping a natural contour to the faces 400-406 without any apparent discontinuities is important to ensure varying sized hands may grip the container and to providing an ergonomic gripping surface.

Another consideration for the consumer is the appearance of the housing 52, which preferably has a natural look, such as a smooth or textured pebble. With this consideration in mind, the housing 52 has been provided with the smooth or textured curvilinear sides 54 that give the impression of lacking any man-made features. The curvilinear sides 54 may also be provided with a natural looking pattern, such as a wood grain, a stone pattern with or without inclusions, a fossil pattern, etc. It has been found that shaping the housing 52 to mimic the shape of a natural occurring object provides the above-noted benefits to gripping the surface of the housing 52. It has also been found that shaping the housing 52 like a naturally occurring object has the added aesthetic benefit of blending into surroundings in a home, work, or other environment more easily, i.e., the aerosol dispenser 50 does not intrusively stand in the user's environment and appear as a man-made aerosol dispenser. Other shapes presently contemplated include stones, shells, or any other natural occurring object, insofar as the shape lacks any discontinuities, straight lines, or right angles over the faces 400-406.

Any of the embodiments described herein may be modified to include any of the structures or methodologies disclosed in connection with different embodiments. Further, the present disclosure is not limited to the housing 52 as specifically shown. Also a pump spray can be used in place of an aerosol.

### INDUSTRIAL APPLICABILITY

An aerosol dispenser may commonly be used to dispense a volatile material stored within an aerosol container. Commonly sold aerosol containers can include volatile materials such as air fresheners, deodorants, insecticides, germicides, decongestants, perfumes, and the like and can have a variety of lengths and/or widths. An aerosol dispenser is presented that can accommodate aerosol containers of different lengths and/or widths. Further, an aerosol dispenser is presented that has an ergonomic housing adapted to assist a user in gripping and actuating the dispenser.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

I/we claim:

1. A dispenser, comprising:
a housing (52) having curvilinear sides (54), a top end (56), and a bottom end (58), wherein at least one face of the curvilinear sides (54) is shaped to appear like a natural occurring object and includes a portion between the top end (56) and the bottom end (58) that extends radially from a longitudinal axis (66) of the housing (52) to a greater extent than portions at the top end (56) and the bottom end (58);
a bore (60) extending through the housing (52), which is adapted to receive a container (100), wherein the container (100) is adapted to dispense fluid through a first aperture (62) of the bore (60) in the top end (56) of the housing (52); and
characterized in that fluid is dispensed from the container (100) through the first aperture (62) upon telescopically moving the housing (52) by exerting a force against the at least one face of the curvilinear sides (54) shaped to appear like a natural occurring object in a direction parallel to the longitudinal axis (66) of the housing (52).

2. The dispenser of claim 1, wherein the container (100) is placed within the bore (60) through a second aperture (64) at the bottom end (58) thereof.

3. The dispenser of claim 1, wherein the at least one face of the curvilinear sides (54) is adapted to fit the contour of a user's palm and provides an ergonomic gripping surface.

4. The dispenser of claim 1, wherein the curvilinear sides comprise a first face (400), a second face (402), a third face (404), and a fourth face (406).

5. The dispenser of claim 4, wherein a medial portion (410) of the faces (400, 402, 404, 406) extends radially outwardly from the longitudinal axis (66) of the housing (52) to a greater extent than portions of the faces (400, 402, 404, 406) adjacent the top end (56) and the bottom end (58).

6. The dispenser of claim 4, wherein the faces (400, 402, 404, 406) extend radially outwardly from the longitudinal axis (66) of the housing (52) the entire length of the housing (52) between the top end (56) and the bottom end (58).

7. The dispenser of claim 1, wherein the natural occurring object is one of a pebble, a stone, or a shell.

8. The dispenser of claim 1, wherein the container (100) is an aerosol container or a pump spray.

9. A dispenser, comprising:
a housing (52) having a bore (60) extending therethrough, the bore (60) having first and second apertures (62), (64);
an actuator socket (204, 300) disposed within the first aperture (62), including a passage (206, 304) extending therethrough that is in fluid communication with the first aperture (62);
a shroud (200, 250) disposed within the bore (60), the shroud including a channel within an interior thereof;
an adapter (350) that engages the shroud (200, 250) and is disposed within the second aperture (64);
an aerosol container (100) disposed within the channel of the shroud (200, 250), the shroud (200, 250) having shoulders (218) to hold the aerosol container (100) at an axially fixed position with respect to the shroud (200, 250), wherein a valve stem (114) of the aerosol container (100) is urged by the actuator socket (204, 300) such that displacement of the housing (52) toward the shroud (200, 250) axially compresses the valve stem (114) to cause the aerosol container (100) to emit fluid through the passage (206, 304) and the first aperture (62); and
characterized in that the shroud (200, 250) slidably engages the housing (52) to allow a limited telescopic movement therebetween, wherein the adapter (350) releasably engages a lower portion of the shroud (200, 250) to enable the shroud (200, 250) and the aerosol container (100) to be removed axially as a unit.

10. The dispenser of claim 9, wherein the shroud (200) includes a body portion (202) and flexible members (208) extending between the body portion (202) and the actuator socket (204).

11. The dispenser of claim 10, wherein the shroud (200) is provided with an aerosol container (100) therein such that the valve stem (114) of the aerosol container (100) is disposed within an inlet (220) of the actuator socket (204) and the actuator socket (204) is in fluid communication with the first aperture (62).

12. The dispenser of claim 9, wherein the shroud (250) includes a body portion (202) and the actuator socket (300) is separate therefrom and integral with portions of the housing (52) adjacent the first aperture (62).

13. The dispenser of claim 12, wherein the shroud (250) is provided with an aerosol container (100) therein such that the valve stem (114) of the aerosol container (100) is disposed within an inlet (302) of the actuator socket (300) and the actuator socket (300) is in fluid communication with the first aperture (62).

14. The dispenser of claim 13, wherein the passage (304) of the actuator socket (300) comprises a frusto-conical inlet portion (302) adapted to receive any of a plurality of valve stems of an aerosol container having a uniformly cylindrical cross-section or a non-uniform cylindrical cross-section.

15. The dispenser of claim 9, wherein interior portions of the adapter (350) include at least one support member (358) configured to engage at least one protrusion (216) of a shoulder (210) extending from an exterior of the shroud (200, 250).

16. A dispenser, comprising:
a housing (52) having sides (54), a top end (56), and a bottom end (58), wherein a portion between the top end (56) and the bottom end (58) extends outwardly from an axis (66) of the housing (52) to a greater extent than portions at the top end (56);
a bore (60) extending through the housing (52), which is adapted to receive a container (100), wherein the container (100) is adapted to dispense a volatile material through a first aperture (62) of the housing (52); and
characterized in that fluid is dispensed from the container (100) through the first aperture (62) upon moving the housing (52) by exerting a force against at least one face of the sides (54) in a direction substantially parallel to the axis (66) of the housing (52), wherein one face of the sides is shaped to appear like at least one of a pebble, a stone, a fossilized article, and a wood article.

17. The dispenser of claim 16, wherein the container (100) is placed within the bore (60) through a second aperture (64) at the bottom end (58) thereof.

18. The dispenser of claim 16, wherein the container (100) is an aerosol container.

19. The dispenser of claim 16, wherein the sides (54) of the housing (52) are curvilinear.

20. The dispenser of claim 19, wherein the at least one face of the curvilinear sides (54) is adapted to fit the contour of a user's palm and provides an ergonomic gripping surface.

21. The dispenser of claim 20, wherein the curvilinear sides comprise a first face (400), a second face (402), a third face (404), and a fourth face (406).

22. The dispenser of claim 21, wherein a medial portion (410) of the faces (400, 402, 404, 406) extends radially outwardly from the longitudinal axis (66) of the housing (52) to a greater extent than portions of the faces (400, 402, 404, 406) adjacent the top end (56) and the bottom end (58).

23. The dispenser of claim 22, wherein the faces (400, 402, 404, 406) extend radially outwardly from the longitudinal axis (66) of the housing (52) the entire length of the housing (52) between the top end (56) and the bottom end (58).

24. The dispenser of claim 16, wherein fluid is dispensed upon telescopically moving the housing (52) in relation to a shroud (200, 250).

25. The dispenser of claim 16, wherein the fluid is dispensed upon exerting a force against at least the one face of the sides (54) that is shaped to appear like at least one of a pebble, a stone, a fossilized article, and a wood article.
